(19) United States
(12) Patent Application Publication
(10) Pub. No.: US 2013/0059210 A1
(43) Pub. Date: Mar. 7, 2013

(54) ELECTROLYTE FOR RECHARGEABLE LITHIUM BATTERY AND RECHARGEABLE LITHIUM BATTERY INCLUDING SAME

(71) Applicants: Jung-Yi YU, Yongin-si (KR); Woo-Cheol SHIN, Yongin-si (KR); Sang-II HAN, Yongin-si (KR); Mi-Hyun LEE, Yongin-si (KR); Tae-Hyun BAE, Yongin-si (KR)

(72) Inventors: Jung-Yi YU, Yongin-si (KR); Woo-Cheol SHIN, Yongin-si (KR); Sang-II HAN, Yongin-si (KR); Mi-Hyun LEE, Yongin-si (KR); Tae-Hyun BAE, Yongin-si (KR)

(73) Assignee: SAMSUNG SDI CO., LTD., Yongin-si (KR)

(21) Appl. No.: 13/462,147

(22) Filed: May 2, 2012

(30) Foreign Application Priority Data
Sep. 5, 2011 (KR) 10-2011-0089794

(51) Int. Cl. H01M 10/26

(52) U.S. Cl. 429/338; 429/207; 429/342; 429/343; 429/341; 429/200

(57) ABSTRACT

An electrolyte for a rechargeable lithium battery and rechargeable lithium battery including the same is provided. The electrolyte includes a film-forming compound; a lithium salt; and an organic solvent.

### CROSS-REFERENCE TO RELATED APPLICATIONS

This application claims priority to and the benefit of Korean Patent Application No. 10-2011-0089794 filed on Sep. 5, 2011 in the Korean Intellectual Property Office, the disclosure of which is incorporated in its entirety herein by reference.

### BACKGROUND

1. Field

This disclosure relates to an electrolyte for a rechargeable lithium battery and a rechargeable lithium battery including the same.

2. Description of the Related Technology

Lithium rechargeable batteries using an organic electrolyte solution can have twice or more the discharge voltage than that of a conventional battery using an alkali aqueous solution, and accordingly have high energy density.

Composite oxides such as LiCoO₂, LiMn₂O₄, LiNi₁₋ₓCoₓO₂ (0<x<1), and the like, have been researched for positive active materials.

The negative active materials of rechargeable lithium batteries have been made of carbon-based materials such as artificial graphite, natural graphite, and hard carbon, which can all intercalate and deintercalate lithium ions.

One or more lithium salts dissolved in a carbonate-based solvent has been generally used as an electrolyte for rechargeable lithium batteries.

### SUMMARY

One embodiment of this disclosure provides an electrolyte for a rechargeable lithium battery that may improve the high-temperature charge and discharge characteristics of a negative electrode. One embodiment of this disclosure provides an electrolyte for a rechargeable lithium battery that may suppress the generation of gas. One embodiment of this disclosure provides an electrolyte for a rechargeable lithium battery that may improve the high-temperature charge and discharge characteristics of a negative electrode and suppress the generation of gas.

Another embodiment of this disclosure provides a rechargeable lithium battery including the electrolyte.

Some embodiments provide an electrolyte for a rechargeable lithium battery that includes a film-forming compound including a carbon-carbon unsaturated bond and a Lewis acid residual group; a lithium salt; and an organic solvent. Some embodiments provide an electrolyte for a rechargeable lithium battery that includes a film-forming compound; a lithium salt; and an organic solvent. In certain embodiments, the film-forming compound may include a carbon-carbon unsaturated bond and a Lewis acid residual group. In certain embodiments, the film-forming compound includes a carbon-carbon unsaturated bond and a Lewis acid residual group. Some embodiments provide an electrolyte for a rechargeable lithium battery that includes a film-forming compound; a lithium salt; and an organic solvent. In certain embodiments, the film-forming compound may include a carbon-carbon unsaturated bond and a Lewis acid residual group. In certain embodiments, the film-forming compound may be at least one of the compounds represented by the following Chemical Formulas 1 to 8:

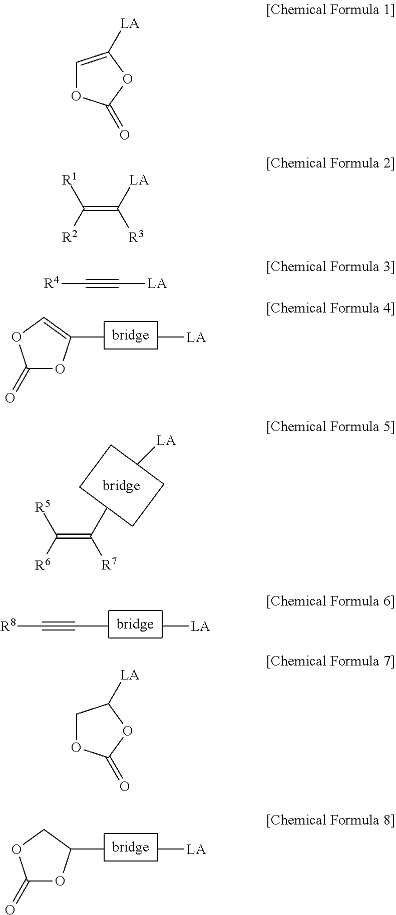

wherein, R¹ to R³ and R⁵ to R⁷ are the same or different and are each independently hydrogen; an unsubstituted or substituted alkyl group; an unsubstituted or substituted alkoxy group; an unsubstituted or substituted aryl group; or an unsubstituted or substituted amino group,

R⁴ and R⁵ are the same or different and are each independently hydrogen; an unsubstituted or substituted alkyl group; an unsubstituted or substituted alkoxy group; an unsubstituted or substituted aryl group; or an unsubstituted or substituted amino group,

LA includes a Lewis acid residual group, and

bridge is oxygen (O); an unsubstituted or substituted alkyl group; an unsubstituted or substituted aryl group; an unsubstituted or substituted ether group; an unsubstituted or substituted alkylene group; an unsubstituted or substituted alkynyl group; or an unsubstituted or substituted amide group. In certain embodiments, LA is —BR²⁰R²¹, —B(OR²⁰)(OR²¹), —AlR²⁰R²¹, or —Al(OR²⁰)(OR²¹);

R²⁰ and R²¹ are the same or different and are each independently an unsubstituted or substituted alkyl, an unsubstituted or substituted aryl. an unsubstituted or substituted alkoxy, an unsubstituted or substituted alkenyl, an unsubstituted or substituted alkynyl; or an unsubstituted or substituted amino group, or —B(OR²⁰)(OR²¹) is an unsubstituted or substituted

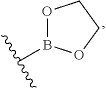 [SMILES: *B1OCCO1]

an unsubstituted or substituted

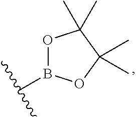 [SMILES: *B1OC(C)(C)C(C)(C)O1]

an unsubstituted or substituted

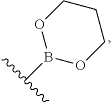 [SMILES: *B1OCCCO1]

an unsubstituted or substituted

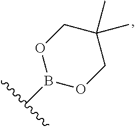 [SMILES: *B1OCC(C)(C)CO1]

an unsubstituted or substituted

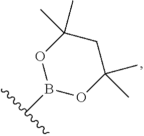 [SMILES: *B1OC(C)(C)CC(C)(C)O1]

or an unsubstituted or substituted

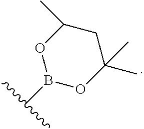 [SMILES: *B1OC(C)CC(C)(C)O1]

In certain embodiments, LA is —B(OR²⁰)(OR²¹) wherein —B(OR²⁰)(OR²¹) is unsubstituted or substituted

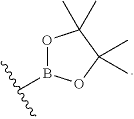 [SMILES: *B1OC(C)(C)C(C)(C)O1]

In certain embodiments, the film-forming compound is 1-cyclohexen-1-yl-boronic acid pinacol ester, vinylboronic acid pinacol ester, allylboronic acid pinacol ester, isopropenylboronic acid pinacol ester, 2,3-diihydro-5-furylboronic acid pinacol ester, vinylboronic acid dibutyl ester, 2-cyclopropylvinylboronic acid pinacol ester, 1-pentynylboronic acid pinacol ester 3-hexenyl-3-boronic acid catechol ester, 2-(thiophen-3-yl)vinylboronic acid pinacol ester, vinylboronic acid pinanediol ester, 3,3-dimethyl-1-butynyl)boronic acid diisopropyl ester, trans-(3,3-dimethylbuten-1-yl)boronic acid pinacol ester, 1-hexen-1-yl-boronic acid pinacol ester, 2-(3,5-difluorophenyl)vinyl boronic acid pinacol ester, 3-(tert-butyldimethylsilyloxy)propene-1-yl-boronic acid pinacol ester, 4-(tert-butyldimethylsiloxy)-1-buten-1-yl-boronic acid pinacol ester, 1-hexene-1,2-diboronic acid bis(pinacol) ester, 2-(4-pentylphenyl)vinylboronic acid pinacol ester, or combinations thereof. In certain embodiments, the electrolyte includes vinylethyl carbonate, vinylene carbonate, or an ethylene carbonate-based compound of the following Chemical Formula 10:

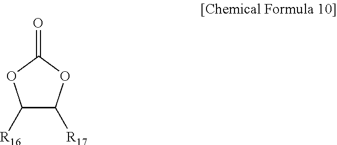

wherein, in Chemical Formula 10, R₁₆ and R₁₇ are each independently selected from the group consisting of hydrogen, a halogen, a cyano group (CN), a nitro group (NO₂), and a fluorinated C1 to C5 alkyl group, and at least one of R₁₆ and R₁₇ is selected from the group consisting of a halogen, a cyano group (CN), a nitro group (NO₂), and a fluorinated C1 to C5 alkyl group, provided that R₁₆ and R₁₇ are not simultaneously hydrogen. In certain embodiments, the lithium salt is LiPF₆. In certain embodiments, the film-forming compound is 1-cyclohexen-1-yl-boronic acid pinacol ester. In certain embodiments, the organic solvent is a mixture of ethylene carbonate (EC), ethylmethyl carbonate (EMC) and dimethyl carbonate.

In certain embodiments, the film-forming compound may include at least one of the compounds represented by the following Chemical Formulas 1 to 8.

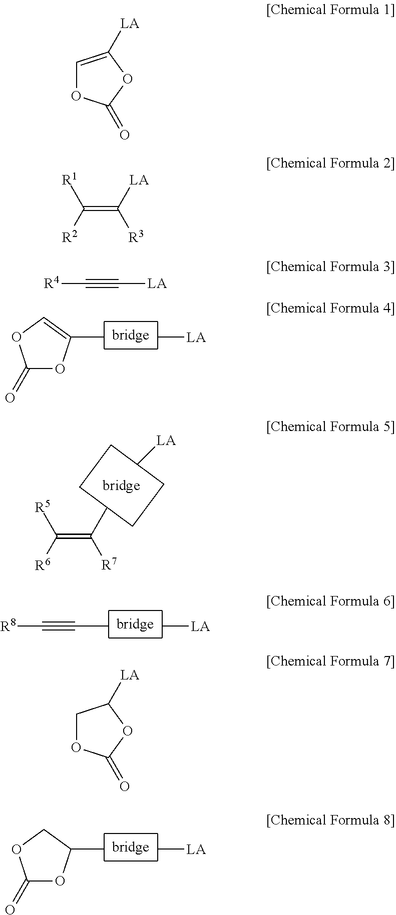

In Chemical Formulas 1 to 8, R¹ to R³ and R⁵ to R⁷ may be the same or different and are each independently hydrogen; an alkyl group; an alkoxy group; an aryl group; or an amino group,

R⁴ and R⁵ may be the same or different and are each independently hydrogen; an alkyl group; an alkoxy group; an aryl group; or an amino group,

LA may include a Lewis acid residual group, and

bridge may be O (oxygen); an alkyl group; an aryl group; an ether group; an alkylene group; an alkynyl group; or an amide group.

In certain embodiments, the Lewis acid residual group may include a B (boron), Al (aluminum), P (phosphorus), or S (sulfur) moiety, or a combination thereof.

In certain embodiments, the film-forming compound may include vinylboronic acid pinacol ester, allylboronic acid pinacol ester, isopropenylboronic acid pinacol ester, 2,3-diihydro-5-furylboronic acid pinacol ester, vinylboronic acid dibutyl ester, 2-cyclopropylvinylboronic acid pinacol ester, 1-pentynylboronic acid pinacol ester, 3-hexenyl-3-boronic acid catechol ester, 2-(thiophen-3-yl)vinylboronic acid pinacol ester, vinylboronic acid pinanediol ester, 1-cyclohexen-1-yl-boronic acid pinacol ester, (3,3-dimethyl-1-butynyl)boronic acid diisopropyl ester, trans-(3,3-dimethylbuten-1-yl)boronic acid pinacol ester, 1-hexen-1-yl-boronic acid pinacol ester, 2-(3,5-difluorophenyl)vinyl boronic acid pinacol ester, 3-(tert-butyldimethylsilyloxy)propene-1-yl-boronic acid pinacol ester, 4-(tert-butyldimethylsiloxy)-1-buten-1-yl-boronic acid pinacol ester, 1-hexene-1,2-diboronic acid bis(pinacol) ester, 2-(4-pentylphenyl)vinylboronic acid pinacol ester, or a combination thereof.

In certain embodiments, the film-forming compound may be included in an amount of about 0.01 wt % to about 20 wt % based on the total weight of the electrolyte.

In certain embodiments, the organic solvent may include a carbonate-based, ester-based, ether-based, ketone-based, alcohol-based, aprotic solvent, or a combination thereof. In certain embodiments, the organic solvent may a non-aqueous organic solvent.

In certain embodiments, the electrolyte may further include vinylethyl carbonate, vinylene carbonate or an ethylene carbonate-based compound of the following Chemical Formula 10.

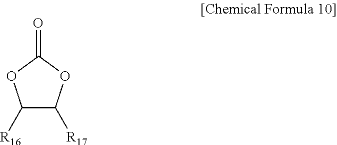

In Chemical Formula 10, R₁₆ and R₁₇ can each be independently selected from the group consisting of hydrogen, a halogen, a cyano group (CN), a nitro group (NO₂), and a fluorinated C1 to C5 alkyl group, and at least one of R₁₆ and R₁₇ can be selected from the group consisting of a halogen, a cyano group (CN), a nitro group (NO₂), and a fluorinated C1 to C5 alkyl group, provided that both R₁₆ and R₁₇ are not simultaneously hydrogen.

In certain embodiments, the lithium salt may be LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(SO₂CₓF₂ₓ₊₁)(SO₂C_{y}F_{2y+1}) wherein x and y are natural number, LiCl, LiI, LiB(C₂O₄)₂ (lithium bis(oxalato) borate; LiBOB), or a combination thereof.

Some embodiments provide an electrolyte for a rechargeable lithium battery including a film-forming compound selected from diethylaluminum cyanide, diethylaluminum ethoxide, phenyl vinylsulfonate, propargyl benzenesulfonate, 2-bytunyl p-toluenesulfonate, or a combination thereof; a lithium salt; and an organic solvent.

Some embodiments provide a rechargeable lithium battery that includes a negative electrode including a negative active material; a positive electrode including a positive active material; and an electrolyte.

In certain embodiments, a film including a Lewis acid residual group may form on the surface of the positive electrode when the rechargeable lithium battery is charged and discharged at about 1 C or less in one to three times.

In certain embodiments, the negative active material may be a carbon-based active material.

Hereinafter, further embodiments of this disclosure will be described in detail.

Some embodiments provide an electrolyte for a rechargeable lithium battery that may have improved charge and discharge characteristics and inhibits a reaction between the positive electrode and the electrolyte at an interface of the positive active material.

### BRIEF DESCRIPTION OF THE DRAWINGS

FIG. 1 is a schematic view showing a lithium secondary battery according to one embodiment.

FIG. 2 is a graph of the discharge capacity of the rechargeable lithium battery cells of certain embodiments.

FIG. 3 is a graph of the differential capacity (dQ/dV) of an embodiment.

### DETAILED DESCRIPTION

Exemplary embodiments will hereinafter be described in detail. However, these embodiments are exemplary, and this disclosure is not limited thereto.

In certain embodiments, the electrolyte for a rechargeable lithium battery can include a film-forming compound including a carbon-carbon unsaturated bond and a Lewis acid residual group, a lithium salt, and an organic solvent. In certain embodiments, the organic solvent can be anhydrous

In certain embodiments, the film-forming compound may include at least one of the compounds represented by the following Chemical Formulas 1 to 8.

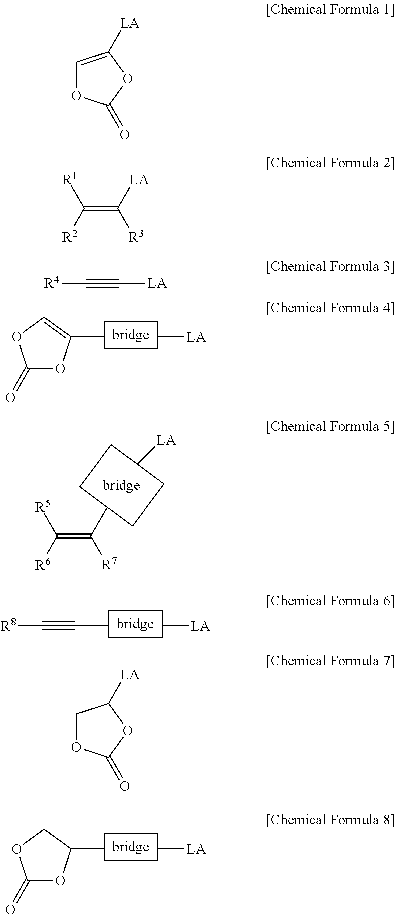

In Chemical Formulas 1 to 8, R¹ to R³ and R⁵ to R⁷ may be the same or different and are each independently hydrogen; an alkyl group; an alkoxy group; an aryl group; or an amino group,

R⁴ and R⁸ may be the same or different and are each independently hydrogen; an alkyl group; an alkoxy group; an aryl group; or an amino group,

LA can include a Lewis acid residual group, and

bridge can be (O) oxygen; an alkyl group; an aryl group; an ether group; an alkylene group; an alkynyl group; or an amide group.

As used herein, when a specific definition is not otherwise provided, definition of each functional group is as follows.

As used herein, the term “alkyl” refers to a branched or unbranched, or cyclic fully saturated aliphatic hydrocarbon group. In some embodiments, alkyls may be substituted or unsubstituted. Alkyls include, but are not limited to, methyl, ethyl, propyl, isopropyl, butyl, isobutyl, tertiary butyl, pentyl, hexyl, cyclopropyl, cyclopentyl, cyclohexyl, cycloheptyl and the like, each of which may be optionally substituted in some embodiments. In some embodiments, the alkyl may have C1 to C7 carbon atoms. For example, C₁₋₇alkyl includes, but is not limited to, methyl, ethyl, propyl, isopropyl, butyl, iso-butyl, sec-butyl, pentyl, 3-pentyl, hexyl, cyclopropyl, cyclobutyl cyclopentyl, cyclohexyl, and the like. As used herein, “haloalkyl” refers to an alkyl group-, covalently bonded to the parent molecule through a —C— linkage, in which one or more of the hydrogen atoms are replaced by halogen. Such groups include, but are not limited to, chloromethyl, fluoromethyl, difluoromethyl, trifluoromethyl and 1-chloro-2-fluoromethyl, 2-fluoroisobutyl. A haloalkyl may be substituted or unsubstituted. As used herein, “halo” refers to F (fluoro), Cl (chloro), Br (bromo) or I (iodo). In certain embodiments, the “halo” may be —F (fluoride), —Cl (chloride), —Br (bromide), or —I (iodide) as the anion component of a salt.

As used herein, the term “alkoxy” refers to an alkyl radical covalently bonded to the parent molecule through an —O— linkage. In some embodiments, alkoxys may be substituted or unsubstituted. Examples of alkoxy groups include, but are not limited to, methoxy, ethoxy, propoxy, isopropoxy, butoxy, n-butoxy, sec-butoxy, t-butoxy, cyclopropyloxy, cyclobutyloxy, cyclopentyloxy, cyclohexyloxy cycloheptyloxy, trifluoromethoxy, pentafluoroethoxy, 2,2,2-trifluoroethoxy, 1,1-difluoroethoxy, 1-fluoroethoxy, and the like. In some embodiments, the alkoxy may have C1 to C10 carbon atoms.

As used herein, the term “alkenyl” refers to a radical of from two to twenty carbon atoms containing at least one carbon-carbon double bond including, but not limited to, 1-propenyl, 2-propenyl, 2-methyl-1-propenyl, 1-butenyl, 2-butenyl, cyclopropenyl, cyclopentenyl, cyclohexenyl, cycloheptenyl and the like. In some embodiments, alkenyls may be substituted or unsubstituted. In some embodiments, the alkenyl may have C2 to C4 carbon atoms. As used herein, the term “alkynyl group” refers to a monovalent straight or branched chain radical of from two to twenty carbon atoms containing at least one carbon-carbon triple bond including, but not limited to, 1-propynyl, 1-butynyl, 2-butynyl, and the like. In some embodiments, alkynyls may be substituted or unsubstituted. In some embodiments, the alkynyl may have C2 to C4 carbon atoms.

As used herein, the term “aryl” refers to aromatic radical having one ring and optionally an appended ring, or multiple fused rings. Examples of aryl groups include, but are not limited to, phenyl, biphenyl, naphthyl, phenanthrenyl, naphthacenyl, and the like. In some embodiments, aryls may be substituted or unsubstituted. In some embodiments, the aryl can be a “heteroaryl” group. As used herein, the term “heteroaryl” refers refers to an aromatic ring system radical in which one or more ring atoms are not carbon, namely heteroatom, having one ring or multiple fused rings. In fused ring systems, the one or more heteroatoms may be present in only one of the rings. Examples of heteroatoms include, but are not limited to, oxygen, sulfur and nitrogen. Examples of heteroaryl groups include, but are not limited to, furanyl, thienyl, imidazolyl, quinazolinyl, quinolinyl, isoquinolinyl, quinoxalinyl, pyridinyl, pyrrolyl, oxazolyl, indolyl, and the like.

In some embodiments, the cyclic alkyl group may be a substituted or unsubstituted C₃ to C₆ cyclic alkyl group. Examples of C₃₋₆cycloalkyls include, but are not limited to, cyclopropyl, cyclobutyl cyclopentyl, and cyclohexyl.

The term “ether group” may refer to a C1 to C10 ether group. Examples of ether groups include methoxymethyl (—CH₂OCH₃), ethoxymethyl (—CH₂OCH₂CH₃), trifluoromethoxymethyl (—CH₂OCF₃), difluoromethoxymethyl (—CH₂OCF₂H), fluoromethoxymethyl (—CH₂OCFH₂), 2,2,2-trifluoroethoxymethyl (—CH₂OCH₂CF₃), 2,2-difluoroethoxymethyl (—CH₂OCH₂CF₂H), 2-fluoroethoxymethyl (—CH₂OCH₂CFH₂), methoxyethyl(—CH₂CH₂OCH₃), ethoxyethyl (—CH₂CH₂OCH₂CH₃), trifluoromethoxyethyl(—CH₂CH₂OCF₃), difluoromethoxyethyl(—CH₂CH₂OCF₂H), fluoromethoxyethyl(—CH₂CH₂OCFH₂), 2,2,2-trifluoroethoxyethyl (—CH₂CH₂OCH₂CF₃), 2,2-difluoroethoxyethyl (—CH₂CH₂OCH₂CF₂H), 2-fluoroethoxyethyl (—CH₂CH₂OCH₂CFH₂)

In certain embodiments, the film-forming compound can be diphenylvinylphosphine, diphenylallylphosphine, diallylphenylphosphine, diallylvinylphosphine, 1,2-bis(diphenylphosphino)ethylene, bis(diphenylphosphino)acetylene, 1,1-bis(diphenylphosphino)ethylene, vinylboronic acid pinacol ester, allylboronic acid pinacol ester, isopropenylboronic acid pinacol ester, 2,3-diihydro-5-furylboronic acid pinacol ester, vinylboronic acid dibutyl ester, 2-cyclopropylvinylboronic acid pinacol ester, 1-pentynylboronic acid pinacol ester 3-hexenyl-3-boronic acid catechol ester, 2-(thiophen-3-yl)vinylboronic acid pinacol ester, vinylboronic acid pinanediol ester, 1-cyclohexen-1-yl-boronic acid pinacol ester, 3,3-dimethyl-1-butynyl)boronic acid diisopropyl ester, trans-(3,3-dimethylbuten-1-yl)boronic acid pinacol ester, 1-hexen-1-yl-boronic acid pinacol ester, 2-(3,5-difluorophenyl)vinyl boronic acid pinacol ester, 3-(tert-butyldimethylsilyloxy)propene-1-yl-boronic acid pinacol ester, 4-(tert-butyldimethylsiloxy)-1-buten-1-yl-boronic acid pinacol ester, 1-hexene-1,2-diboronic acid bis(pinacol) ester, 2-(4-pentylphenyl)vinylboronic acid pinacol ester, diethylaluminum cyanide, diethylaluminum ethoxide, phenyl vinylsulfonate, propargyl benzenesulfonate, 2-butynyl p-toluenesulfonate, or a combination thereof.

In certain embodiments, a solid electrolyte interface film (SEI film) including a Lewis acid residual group may be formed on the surface of a positive electrode when a battery using an electrolyte including the film-forming compound is initially charged and discharged. In certain embodiments, when the film including the Lewis acid residual group is formed on the surface of a positive electrode, the Lewis acid residual group included in the film can be coordination-bonded with the organic solvent enhancing the transfer of lithium ions in the electrolyte toward an active material. Accordingly, the dissociation of lithium and the organic solvent can be facilitated and the lithium ions may be smoothly intercalated into the active material.

In certain embodiments, the amount of the film-forming compound may range from about 0.01 wt % to about 20 wt % based on the total weight of the electrolyte. In certain embodiments, the amount of the film-forming compound may range from about 0.05 wt % to about 0.5 wt %. In certain embodiments, when the amount of the film-forming compound falls in the range, a uniform SEI film may be formed on the surface of the positive electrode during the initial charge and discharge of the electrolyte including the film-forming compound, thus preventing the organic solvent of the electrolyte from being intercalated into the active material and preventing the active material from being exfoliated. In certain embodiments, the cycle-life of a battery may be improved by suppressing the continuous decomposition of the electrolyte. For example, when the amount of the film-forming compound ranges from about 0.05 wt % to about 0.5 wt %, then film resistance may not be great and when it is allowed to stand, Open Circuit Voltage (OCV) may scarcely drop.

In certain embodiments, the organic solvent serves as a medium for transferring ions taking part in the electrochemical reaction of the battery in the electrolyte. In certain embodiments, the organic solvent can be anhydrous.

In certain embodiments, the organic solvent may include a carbonate-based, ester-based, ether-based, ketone-based, alcohol-based, or aprotic solvent. Examples of the carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. Examples of the ester-based solvent may include methyl acetate, ethyl acetate, n-propyl acetate, dimethylacetate, methylpropionate, ethylpropionate, γ-butyrolactone, decanolide, valerolactone, mevalonolactone, caprolactone, and the like. Examples of the ether-based solvent include dibutyl ether, tetraglyme, diglyme, dimethoxyethane, 2-methyltetrahydrofuran, tetrahydrofuran, and the like, and examples of the ketone-based solvent include cyclohexanone, and the like. Examples of the alcohol-based solvent include ethanol, isopropyl alcohol and so on, and examples of the aprotic solvent include nitriles such as T-CN wherein T is a C1 to C20 linear, branched, or cyclic hydrocarbon, or includes a double bond, an aromatic ring, or an ether bond), amides such as dimethylformamide, dioxolanes such as 1,3-dioxolane, sulfolanes, and the like. In certain embodiments, the organic solvent can be anhydrous.

In certain embodiments, the organic solvent may be used singularly or in a mixture. When the organic solvent is used in a mixture, the mixing ratio may be controlled in accordance with a desirable battery performance. In certain embodiments, the organic solvent can be anhydrous.

In certain embodiments, the carbonate-based solvent may include a mixture of a cyclic carbonate and a linear carbonate. The cyclic carbonate and the linear carbonate are mixed together at a volume ratio of about 1:1 to 1:9, and when the mixture is used as an electrolyte, the electrolyte performance may be enhanced.

In certain embodiments, the organic solvent may further include mixtures of carbonate-based solvents and aromatic hydrocarbon-based solvents. The carbonate-based solvents and the aromatic hydrocarbon-based solvents may be mixed together at a volume ratio of about 1:1 to about 30:1.

In certain embodiments, the aromatic hydrocarbon-based organic solvent may be represented by the following Chemical Formula 9.

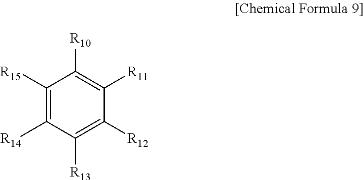

In Chemical Formula 9, R₁₀ to R₁₅ are the same or different and are selected from the group consisting of hydrogen, a halogen, a C1 to C10 alkyl group, a C1 to C10 haloalkyl group, and a combination thereof.

In certain embodiments, the aromatic hydrocarbon-based organic solvent may be selected from the group consisting of benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, and xylene, or a combination thereof.

In certain embodiments, the electrolyte for a rechargeable lithium battery may further include vinylethyl carbonate, vinylene carbonate, or an ethylene carbonate-based compound of the following Chemical Formula 10 in order to improve a cycle-life of a battery.

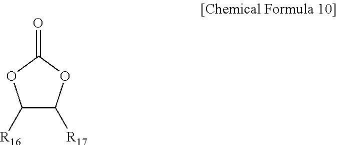

In Chemical Formula 10, R₁₆ and R₁₇ may be each independently selected from the group consisting of hydrogen, a halogen, a cyano group (CN), a nitro group (NO₂), and a fluorinated C1 to C5 alkyl group, and at least one of R₁₆ and R₁₇ is selected from the group consisting of a halogen, a cyano group (CN), a nitro group (NO₂), and a fluorinated C1 to C5 alkyl group, provided that R₁₆ and R₁₇ both are not simultaneously hydrogen.

In certain embodiments, the ethylene carbonate-based compound may include difluoroethylene carbonate, chloroethylene carbonate, dichloroethylene carbonate, bromoethylene carbonate, dibromoethylene carbonate, nitroethylene carbonate, cyanoethylene carbonate or fluoroethylene carbonate, and the like. The use amount of the compounds for improving cycle life may be adjusted within an appropriate range.

In certain embodiments, the lithium salt dissolved in an organic solvent supplies lithium ions in the battery, operates a basic operation of a rechargeable lithium battery, and improves lithium ion transport between positive and negative electrodes. Examples of the lithium salt include, but are not limited to, at least one supporting salt selected from LiPF₆, LiBF₄, LiSbF₆, LiAsF₆, LiN(SO₂C₂F₅)₂, Li(CF₃SO₂)₂N₃ LiN(SO₃C₂F₅)₂, LiC₄F₉SO₃, LiClO₄, LiAlO₂, LiAlCl₄, LiN(CₓF₂ₓ₊₁SO₂)(CyF_{2y+1}SO₂) wherein x and y are natural number, LiCl, LiI, and LiB(O₂O₄)₂ (lithium bis(oxalato) borate; LiBOB). In certain embodiments, the lithium salt may be used at a 0.1 to 2.0M concentration. In certain embodiments, electrolyte performance and lithium ion mobility may be enhanced due to optimal electrolyte conductivity and viscosity when the lithium salt is at a 0.1 to 2.0M concentration.

Some embodiments provide a rechargeable lithium battery including: a negative electrode including a negative active material; a positive electrode including a positive active material; and an electrolyte.

Some embodiments provide a rechargeable lithium battery including a fSEI film that may form on the surface of an active material surface to include a Lewis acid residual group during the initial charge and discharge, such as at about 1 C or less. In certain embodiments, the film forms on the surface of an active material surface including a Lewis acid residual group when a charge and discharge is performed at about 0.2 to about 0.5 C from one to three times. In certain embodiments, an organic solvent can interact with the Lewis acid residual group of the SEI film so that lithium ions are smoothly intercalated into a negative active material, during a charge and discharge process. Thus, a problem such as the destruction of a negative electrode may be suppressed.

In certain embodiments, the negative electrode may include a current collector and a negative active material layer formed over the current collector and including a negative active material.

In certain embodiments, a material may be used as the negative active material that reversibly intercalates/deintercalates lithium ions, a lithium metal, a lithium metal alloy, a material being capable of doping and dedoping lithium, or a transition metal oxide.

In certain embodiments, the material that reversibly intercalates/deintercalates lithium ions may include carbon materials. In certain embodiments, the carbon material may be any generally-used carbon-based negative active material in a lithium ion rechargeable battery. Examples of the carbon-based negative active material include, but are not limited to, crystalline carbon, amorphous carbon or a mixture thereof. In certain embodiments, the crystalline carbon may be non-shaped, or sheet, flake, spherical, or fiber shaped natural graphite or artificial graphite. In certain embodiments, the amorphous carbon may be a soft carbon, a hard carbon, mesophase pitch carbonized product, fired coke, and the like.

Examples of the lithium metal alloy include lithium and a metal selected from the group consisting of Na, K, Rb, Cs, Fr, Be, Mg, Ca, Sr, Si, Sb, Pb, In, Zn, Ba, Ra, Ge, Al, and Sn.

Examples of the material being capable of doping and dedoping lithium include Si, SiOₓ (0<x<2), Si-Q alloy (wherein Q is an element selected from the group consisting of an alkali metal, an alkaline-earth metal, a Group 13 element, a Group 14 element, a Group 15 element, a Group 16 element, a transition element, a rare earth element, and a combination thereof, and is not Si), a Si-carbon composite, Sn, SnO₂, a Sn—R alloy (wherein R is an element selected from the group consisting of an alkali metal, an alkaline-earth metal, a Group 13 element, a Group 14 element, a Group 15 element, a Group 16 element, a transition element, a rare earth element, and a combination thereof, and not Sn), a Sn-carbon composite, and the like. At least one of these materials may be mixed with SiO₂. In certain embodiments, Q and R may be selected from Mg, Ca, Sr, Ba, Ra, Sc, Y, Ti, Zr, Hf, Rf, V, Nb, Ta, Cr, Mo, W, Tc, Re, Fe, Pb, Ru, Os, Rh, Ir, Pd, Pt, Cu, Ag, Au, Zn, Cd, B, Al, Ga, Sn, In, Ti, Ge, P, As, Sb, Bi, S, Se, Te, Po, and a combination thereof.

Examples of the transition metal oxide include lithium titanium oxide.

In certain embodiments, the negative active material layer includes a negative active material and a binder, and optionally a conductive material.

In certain embodiments, the negative active material layer may include about 95 wt % to about 99 wt % of a negative active material based on the total weight of the negative active material layer. In certain embodiments, the negative active material layer may include about 1 wt % to about 5 wt % of a binder based on the total weight of the negative active material layer. In certain embodiments, the negative active material layer may include about 90 wt % to about 98 wt % of a negative active material, about 1 to about 5 wt % of a binder, and about 1 wt % to about 5 wt % of a conductive material when the negative active material layer further includes a conductive material.

In certain embodiments, the binder may improve binding properties of the negative active material particles to each other and to a current collector. In certain embodiments, the binder may include a non-water-soluble binder, a water-soluble binder, or a combination thereof.

In certain embodiments, the non-water-soluble binder may include polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof.

In certain embodiments, the water-soluble binder may include a styrene-butadiene rubber, an acrylated styrene-butadiene rubber, polyvinyl alcohol, sodium polyacrylate, a copolymer of propylene and a C2 to C8 olefin, a copolymer of (meth)acrylic acid and (meth)acrylic acid alkyl ester, or a combination thereof.

In certain embodiments, a cellulose-based compound may be further used to provide viscosity when a water-soluble binder is used as a negative electrode binder. In certain embodiments, the cellulose-based compound can include one or more of carboxylmethyl cellulose, hydroxypropylmethyl cellulose, methyl cellulose, or alkali metal salts thereof. In certain embodiments, the alkali metal may be Na, K, or Li. In certain embodiments, the cellulose-based compound may be included in an amount of about 0.1 parts to about 3 parts by weight based on 100 parts by weight of the negative active material.

In certain embodiments, the conductive material may be included to improve electrode conductivity. Any electrically conductive material may be used as a conductive material unless it causes a chemical change. Examples of the conductive material include, but are not limited to, a carbon-based material such as natural graphite, artificial graphite, carbon black, acetylene black, ketjen black, a carbon fiber, and the like; a metal-based material such as a metal powder or a metal fiber of copper, nickel, aluminum, silver, and the like; a conductive polymer such as polyphenylene derivative; or a mixture thereof.

In certain embodiments, the negative active material layer may be formed using a method including: mixing a negative active material, a binder and optionally a conductive material in a solvent to prepare a negative active material composition, and coating a current collector with the negative active material composition. Methods of forming the negative active material layer are well known by those of skill in the art. In certain embodiments, the solvent may be an organic solvent. In certain embodiments, the organic solvent may be N-methylpyrrolidone but it is not limited thereto. In certain embodiments, the negative active material composition may be prepared using water as a solvent when the negative active material layer includes a water-soluble binder.

In certain embodiments, the current collector may include a copper foil, a nickel foil, a stainless steel foil, a titanium foil, a nickel foam, a copper foam, and a polymer substrate coated with a conductive metal, or combinations thereof.

In certain embodiments, the positive electrode includes a current collector and a positive active material layer disposed on the current collector. In certain embodiments, the positive active material includes lithiated intercalation compounds that reversibly intercalate and deintercalate lithium ions. Examples of the lithiated intercalation compounds may be one of the compounds of the following Chemical Formulas:

LiₐA_{1-b}X_{b}D₂ (0.90≦a≦1.8, 0≦b≦0.5); LiₐA_{1-b}X_{b}O_{2-c}D_{c} (0.90≦a≦1.8, 0≦b≦0.5, 0≦c≦0.05); LiₐE_{1-b}X_{b}O_{2-c}D_{c} (0.90≦a≦1.8, 0≦b≦0.5, 0≦c≦0.05); LiₐE_{2-b}X_{b}O_{4-c}D_{c} (0.90≦a≦1.8, 0≦b≦0.5, 0≦c≦0.05); LiₐNi_{1-b-c}Co_{b}X_{c}D_{α} (0.90≦a≦1.8, 0≦b≦0.5, 0≦c≦0.5, 0<α≦2); LiₐNi_{1-b-c}Co_{b}X_{c}O_{2-α}T_{α} (0.90≦a≦1.8, 0≦b≦0.5, 0≦c≦0.05, 0<α<2); LiₐNi_{1-b-c}Co_{b}X_{c}O_{2-α}T₂ (0.90≦a≦1.8, 0≦b≦0.5, 0≦c≦0.05, 0<α<2); LiₐNi_{1-b-c}Mn_{b}X_{c}D_{π} (0.90≦a≦1.8, 0≦b≦0.5, 0≦c≦0.05, 0<α≦2); LiₐNi_{1-b-c}Mn_{b}X_{c}O_{2-α}T_{α} (0.90≦a≦1.8, 0≦b≦0.5, 0≦c≦0.05, 0<α<2); LiₐNi_{1-b-c}Mn_{b}X_{c}O_{2-α}T₂ (0.90≦a≦1.8, 0≦b≦0.5, 0≦c≦0.05, 0≦α<2); LiₐNi_{b}E_{c}G_{d}O₂ (0.90≦a≦1.8, 0≦b≦0.9, 0≦c≦0.5, 0.001≦d≦0.1); LiₐNi_{b}Co_{c}Mn_{d}GₑO₂ (0.90≦a≦1.8, 0≦b≦0.9, 0≦c≦0.5, 0≦d≦0.5, 0.001≦e≦0.1); LiₐNiG_{b}O₂ (0.90≦a≦1.8, 0.001≦b≦0.1) LiₐCoG_{b}O₂ (0.90≦a≦1.8, 0.001≦b≦0.1); LiₐMn_{1-b}G_{b}O₂ (0.90≦a≦1.8, 0.001≦b≦0.1); LiₐMn₂G_{b}O₄ (0.90≦a≦1.8, 0.001≦b≦0.1); LiₐMn_{1-g}G_{g}PO₄ (0.90≦a≦1.8, 0≦g≦0.5); QO₂; QS₂; LiQS₂; V₂O₅; LiV₂O₅; LiZO₂; LiNiVO₄; Li_{(3-f)}J₂(PO₄)₃ (0≦f≦2); Li_{(3-f)}Fe₂(PO₄)₃ (0≦f≦2); and LiₐFePO₄ (0.90≦a≦1.8).

In the above Chemical Formulas, A is selected from the group consisting of Ni, Co, Mn, and a combination thereof; X is selected from the group consisting of Al, Ni, Co, Mn, Cr, Fe, Mg, Sr, V, a rare earth element, and a combination thereof; D is selected from the group consisting of O, F, S, P, and a combination thereof; E is selected from the group consisting of Co, Mn, and a combination thereof; T is selected from the group consisting of F, S, P, and a combination thereof; G is selected from the group consisting of Al, Cr, Mn, Fe, Mg, La, Ce, Sr, V, and a combination thereof; Q is selected from the group consisting of Ti, Mo, Mn, and a combination thereof; Z is selected from the group consisting of Cr, V, Fe, Sc, Y, and a combination thereof; and J is selected from the group consisting of V, Cr, Mn, Co, Ni, Cu, and a combination thereof.

In certain embodiments, the lithiated intercalation compound may have a coating layer on the surface thereof, or may be mixed with another lithiated intercalation compound having a coating layer. In certain embodiments, the coating layer may include at least one coating element. In certain embodiments, the coating element included in the coating layer may include Mg, Al, Co, K, Na, Ca, Si, Ti, V, Sn, Ge, Ga, B, As, Zr, or a mixture thereof, or a derivative thereof. In certain embodiments, the coating element derivative can be selected from the group consisting of an oxide of a coating element, a hydroxide of a coating element, an oxyhydroxide of a coating element, a carbon oxide of a coating element, and a hydroxyl carbonate of a coating element. In certain embodiments, the compound for a coating layer may be amorphous or crystalline. In certain embodiments, the coating layer including these elements in the compound may be formed in a method having no adverse influence on properties of a positive active material. For example, the method may include any coating method such as spray coating, dipping, and the like. These methods are well-known to those of skill in the art.

In the positive active material layer, the positive active material may be included in an amount of about 90 wt % to about 98 wt % based on the total weight of the positive active material layer.

In certain embodiments, the positive active material layer may further include a binder and a conductive material. In certain embodiments, the binder and the conductive material may be included in an amount of about 1 wt % to about 5 wt %, based on the total weight of the positive active material layer, respectively.

In certain embodiments, the binder can improve binding properties of positive active material particles to one another and to a current collector. Examples of the binder include, but are not limited to, polyvinylalcohol, carboxylmethylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

In certain embodiments, the conductive material may be included to improve electrode conductivity. Any electrically conductive material may be used as a conductive material that does not cause a chemical change. Examples of the conductive material include, but are not limited to, a carbon-based material such as natural graphite, artificial graphite, carbon black, acetylene black, ketjen black, carbon fiber, and the like; a metal-based material including a metal powder or a metal fiber of copper, nickel, aluminum, silver, and the like; a conductive polymer such as a polyphenylene derivative; or a mixture thereof.

In certain embodiments, the current collector may be Al, but is not limited thereto.

In certain embodiments, the positive electrode may be fabricated in a method including mixing a positive active material, a conductive material, and a binder in a solvent to prepare a positive active material composition, and coating the positive active material composition on a current collector. The electrode manufacturing method is well known by those of skill in the art. In certain embodiments, the solvent includes N-methylpyrrolidone and the like, but is not limited thereto.

In certain embodiments, the rechargeable lithium battery may further include a separator between a negative electrode and a positive electrode, if needed. Such a separator may be formed of polyethylene, polypropylene, polyvinylidene fluoride or multi-layers thereof such as a polyethylene/polypropylene double-layered separator, a polyethylene/polypropylene/polyethylene triple-layered separator, and a polypropylene/polyethylene/polypropylene triple-layered separator.

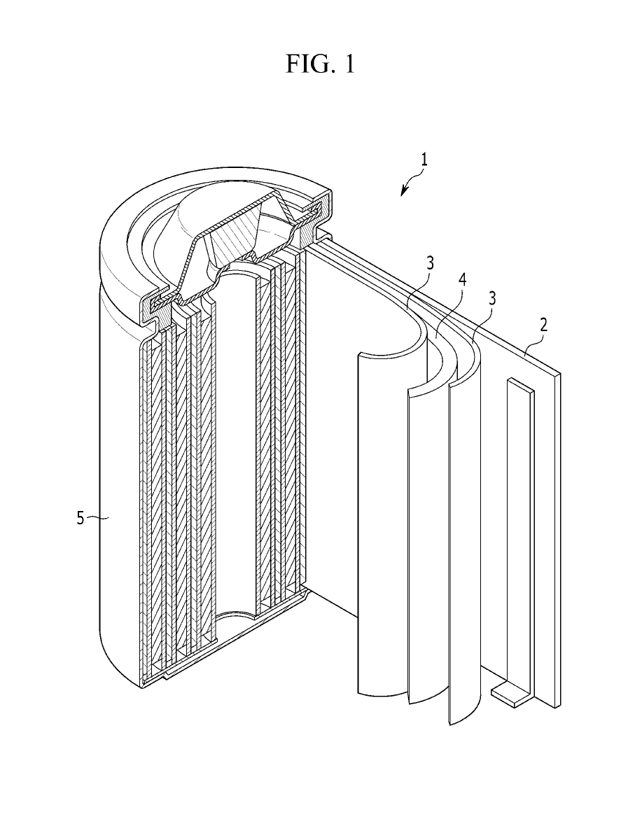

FIG. 1 is a schematic view of a representative structure of a rechargeable lithium battery. As illustrated in FIG. 1, the rechargeable lithium battery 1 includes a battery case 5 including a positive electrode 3, a negative electrode 2, and a separator 4 interposed between the positive electrode 3 and negative electrode 2, an electrolyte impregnated therein, and a sealing member 6 sealing the battery case 5.

Hereinafter, examples of one or more embodiments will be described in detail including comparative examples. However, these examples are not intended to limit the scope of the one or more embodiments.

### Example 1

An electrolyte for a rechargeable lithium battery cell was prepared by adding a LiPF₆ lithium salt to a mixture of ethylene carbonate (EC), ethylmethyl carbonate (EMC) and dimethyl carbonate (DMC) (EC/EMC/DMC=2/2/6 at a volume ratio), and adding a film-forming compound of 1-Cyclohexen-1-yl-boronic acid pinacol ester (CHBE) to the resultant mixture. Herein, the concentration of the lithium salt was about 1.3 M, and the amount of the added film-forming compound was about 0.2 wt % based on the total weight of the electrolyte.

### Example 2

An electrolyte for a rechargeable lithium battery cell was prepared by adding a LiPF₆ lithium salt to a mixture of ethyl carbonate, ethylmethyl carbonate and dimethyl carbonate, and adding fluoroethylene carbonate (FEC) (EC/EMC/DMC=2/2/6 at a volume ratio) and a film-forming compound of 1-cyclohexen-1-yl-boronic acid pinacol ester to the resultant mixture. Herein, the concentration of the lithium salt was about 1.3M, and the amount of the added film-forming compound was about 0.2 wt % based on the total weight of the electrolyte. Also, the amount of the added fluoroethylene carbonate was about 5 wt % based on the total weight of the electrolyte.

### Comparative Example 1

An electrolyte for a rechargeable lithium battery cell was prepared by adding a LiPF₆ lithium salt to a mixture of ethyl carbonate, ethylmethyl carbonate and dimethyl carbonate (EC/EMC/DMC=2/2/6 at a volume ratio). Herein, the concentration of the lithium salt was about 1.3 M.

Capacity Retention Characteristics

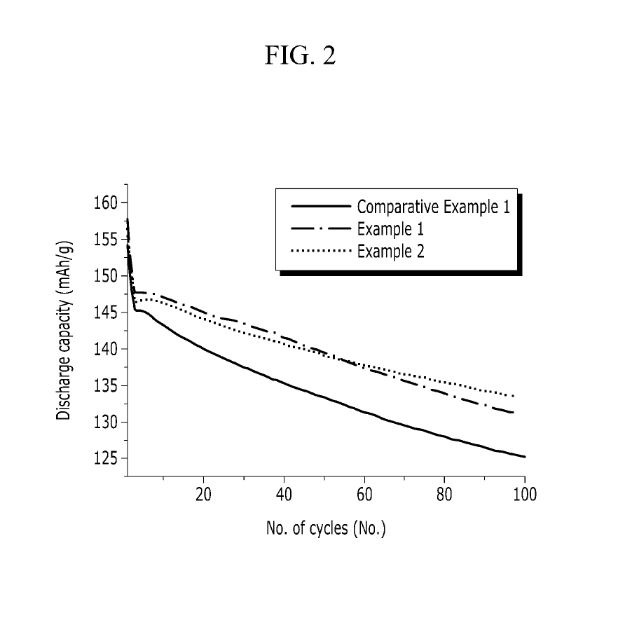

Rechargeable lithium battery cells were fabricated using the electrolytes prepared according to Examples 1 to 2 and Comparative Example 1, respectively. Herein, a positive electrode including a mixed positive active material of LiMn₂O₄ and LiNi_{0.3}Co_{0.3}Mn_{0.3}O₂ (at a mixing ratio of 2:8 in weight) was used as the positive electrode, and a negative electrode including an artificial graphite negative active material was used as the negative electrode. The prepared rechargeable lithium battery cells were charged and discharged at about 25° C. at about 10 for 100 times, and the discharge capacity at each cycle was measured. The results were presented in FIG. 2. It may be seen from FIG. 2 that the capacity retention of the rechargeable lithium battery cells fabricated according to Examples 1 to 2 using the film-forming compound were superior to the capacity retention of the rechargeable lithium battery cells fabricated according to Comparative Example 1 that does not use a film-forming compound.

Measurement of Differential Capacity (dQ/dV)

Coin-type half-cells were fabricated using the electrolytes prepared according to Example 1 and Comparative Example 1. Herein, a positive electrode including a mixed positive active material of LiMn₂O₄ and LiNi_{0.3}Co_{0.3}Mn_{0.3}O₂ (at a mixing ratio of 2:8 in weight) was used, and a lithium metal was used as a counter electrode.

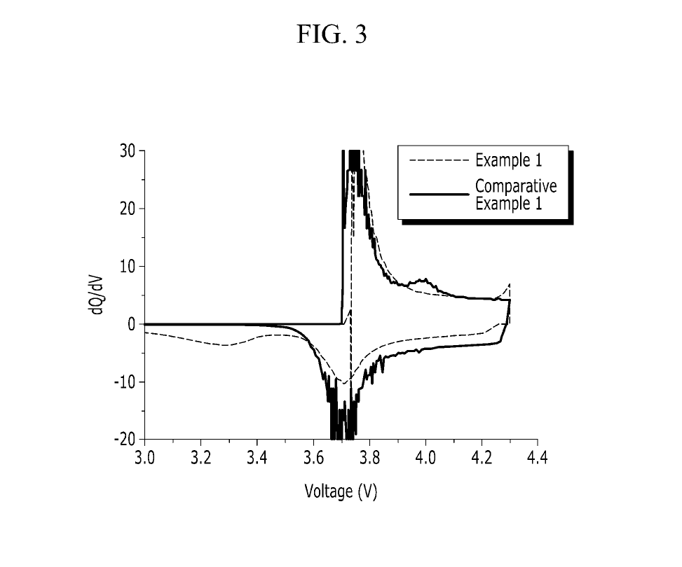

After the half-cells are charged and discharged once at about 0.2 C, their differential capacities (dQ/dV) were measured and the measurement results were presented in FIG. 3. As shown in FIG. 3, the electrolyte of Example 1, a peak appeared at about 3.3V that originates from the decomposition of CHBE. Therefore, it may be seen from the result that when the electrolyte of Example 1 was used, a film may be formed on the surface of the electrode based on the decomposition of CHBE. On the other hand, in case of Comparative Example 1, no peak appeared at about 3.3V.

Unless otherwise indicated, the term “substituted,” refers to a group in which, one, or more than one of the hydrogen atoms has been replaced with one or more group(s) individually and independently selected from: alkyl, alkenyl, cycloalkenyl, alkynyl, heteroalkyl, haloalkyl, cycloalkyl, aryl, alkenylO—, arylO—, alkenylO—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, —C(═O)NHNH₂, heteroaryl, hydroxy, alkoxy, mercapto, cyano, halo, oxo, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, trihalomethanesulfonyl, and amino, including mono- and di-substituted amino groups, and the protected derivatives of amino groups. The protecting groups that can form the protective derivatives of the above substituents are known to those of skill in the art and can be found in references such as Greene and Wuts Protective Groups in Organic Synthesis; John Wiley and Sons: New York, 1999.

The term “O-carboxy” refers to the group consisting of formula RC(═O)O—, covalently bonded to the parent molecule through an —O— linkage.

The term “C-carboxy” refers to the group consisting of formula —C(═O)OR, covalently bonded to the parent molecule through a —C— linkage.

The substituent “R” appearing by itself and without a number designation refers to a substituent selected from alkyl, cycloalkyl, aryl, and heteroaryl (bonded through a ring carbon).

The term “isocyanato” refers to the group consisting of formula —NCO, covalently bonded to the parent molecule through a —N— linkage.

The term “thiocyanato” refers to the group consisting of formula —CNS, covalently bonded to the parent molecule through a —C— linkage.

The term “isothiocyanato” refers to the group consisting of formula —NCS, covalently bonded to the parent molecule through a —N— linkage.

The term “sulfonyl” refers to the group consisting of formula —S(═O)—R, covalently bonded to the parent molecule through a —S— linkage.

The term “S-sulfonamido” refers to the group consisting of formula —S(═O)₂NR, covalently bonded to the parent molecule through a —S— linkage.

The term “N-sulfonamido” refers to the group consisting of formula RS(═O)₂NH—, covalently bonded to the parent molecule through a —N— linkage.

The term “O-carbamyl” refers to the group consisting of formula —OC(═O)—NR, covalently bonded to the parent molecule through a —O— linkage.

The term “N-carbamyl” refers to the group consisting of formula ROC(═O)NH—, covalently bonded to the parent molecule through a —N— linkage.

The term “O-thiocarbamyl” refers to the group consisting of formula —OC(═S)—NR, covalently bonded to the parent molecule through a —O— linkage.

The term “N-thiocarbamyl” refers to the group consisting of formula ROC(═S)NH—, covalently bonded to the parent molecule through a —N— linkage.

The term “C-amido” refers to the group consisting of formula —C(═O)—NR₂, covalently bonded to the parent molecule through a —C— linkage.

The term “N-amido” refers to the group consisting of formula RC(═O)NH—, covalently bonded to the parent molecule through a —N— linkage.

The term “oxo” refers to the group consisting of formula ═O.

The term “amide” refers to a chemical moiety with formula —(R)ₙ—C(═O)NHR′ or —(R)ₙ—NHC(═O)R′, covalently bonded to the parent molecule through a —C— or —N— linkage, where R is selected from alkyl, cycloalkyl, aryl, and heteroaryl (bonded through a ring carbon), where n is 0 or 1 and R′ is selected from hydrogen, alkyl, cycloalkyl, aryl, and heteroaryl (bonded through a ring carbon).

The term “amino” refers to a chemical moiety with formula —NHR′R″, covalently bonded to the parent molecule through a —N— linkage, where R′ and R″ are each independently selected from hydrogen, alkyl, cycloalkyl, aryl, heteroaryl (bonded through a ring carbon) and heteroalicyclic (bonded through a ring carbon).

While the present embodiments have been described in connection with what is presently considered to be practical exemplary embodiments, it is to be understood that the invention is not limited to the disclosed embodiments and is intended to cover various modifications and equivalent arrangements included within the spirit and scope of the appended claims. Therefore, the aforementioned embodiments should be understood to be exemplary but not limiting this disclosure in any way.

What is claimed is:

1. An electrolyte for a rechargeable lithium battery, comprising:
a film-forming compound;
a lithium salt; and
an organic solvent.

2. The electrolyte for a rechargeable lithium battery of claim 1, wherein the film-forming compound is at least one of the compounds represented by the following Chemical Formulas 1 to 8: 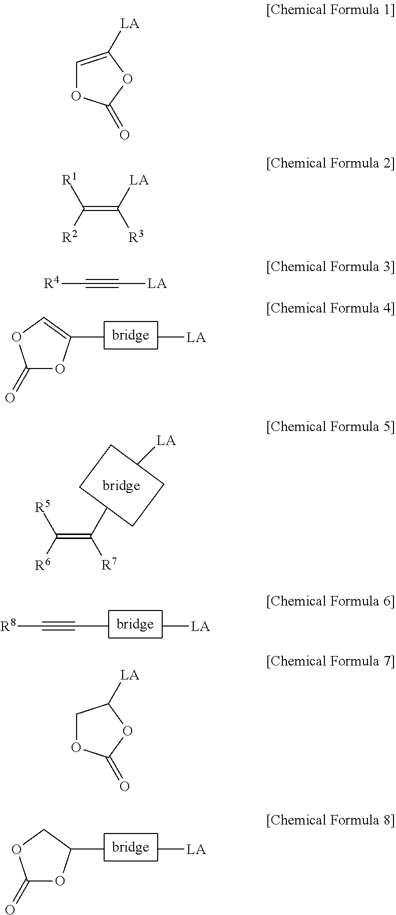
wherein, R¹ to R³ and R⁵ to R⁷ are the same or different and are each independently hydrogen; an alkyl group; an alkoxy group; an aryl group; or an amino group,
R⁴ and R⁸ are the same or different and are each independently hydrogen; an alkyl group; an alkoxy group; an aryl group; or an amino group,
LA includes a Lewis acid residual group, and
bridge is oxygen (O); an alkyl group; an aryl group; an ether group; an alkylene group; an alkynyl group; or an amide group.

3. The electrolyte for a rechargeable lithium battery of claim 1, wherein the Lewis acid residual group is B, Al, P, S, or a combination thereof.

4. The electrolyte for a rechargeable lithium battery of claim 1, wherein the film-forming compound comprises, vinylboronic acid pinacol ester, allylboronic acid pinacol ester, isopropenylboronic acid pinacol ester, 2,3-diihydro-5-furylboronic acid pinacol ester, vinylboronic acid dibutyl ester, 2-cyclopropylvinylboronic acid pinacol ester, 1-pentynylboronic acid pinacol ester, 3-hexenyl-3-boronic acid catechol ester, 2-(thiophen-3-yl)vinylboronic acid pinacol ester, vinylboronic acid pinanediol ester, 1-cyclohexen-1-yl-boronic acid pinacol ester, (3,3-dimethyl-1-butynyl)boronic acid diisopropyl ester, trans-(3,3-dimethylbuten-1-yl)boronic acid pinacol ester, 1-hexen-1-yl-boronic acid pinacol ester, 2-(3,5-difluorophenyl)vinyl boronic acid pinacol ester, 3-(tert-butyldimethylsilyloxy)propene-1-yl-boronic acid pinacol ester, 4-(tert-butyldimethylsiloxy)-1-buten-1-yl-boronic acid pinacol ester, 1-hexene-1,2-diboronic acid bis(pinacol) ester, 2-(4-pentylphenyl)vinylboronic acid pinacol ester.

5. The electrolyte for a rechargeable lithium battery of claim 1, wherein the film-forming compound is included in an amount of about 0.01 wt % to about 20 wt % based on the total weight of the electrolyte.

6. The electrolyte for a rechargeable lithium battery of claim 1, wherein the organic solvent comprises a carbonate-based, ester-based, ether-based, ketone-based, alcohol-based, aprotic solvent, or a combination thereof.

7. The electrolyte for a rechargeable lithium battery of claim 1, wherein the electrolyte comprises vinylethyl carbonate, vinylene carbonate, or an ethylene carbonate-based compound of the following Chemical Formula 10: 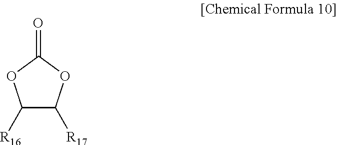
wherein, in Chemical Formula 10, R₁₆ and R₁₇ is each independently selected from the group consisting of hydrogen, a halogen, a cyano group (CN), a nitro group (NO₂), and a fluorinated C1 to C5 alkyl group, and at least one of R₁₆ and R₁₇ is selected from the group consisting of a halogen, a cyano group (CN), a nitro group (NO₂), and a fluorinated C1 to C5 alkyl group, provided that R₁₆ and R₁₇ are not simultaneously hydrogen.

8. The electrolyte for a rechargeable lithium battery of claim 1, wherein the lithium salt comprises LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) wherein x and y are natural number, LiCl, LiI, LiB(C₂O₄)₂ (lithium bis(oxalato) borate; LiBOB), or a combination thereof.

9. A rechargeable lithium battery comprising
a negative electrode including a negative active material;
a positive electrode including a positive active material; and
an electrolyte according to claim 1.

10. The rechargeable lithium battery of claim 9, wherein a film including a Lewis acid residual group is formed on a surface of the positive electrode, after the rechargeable lithium battery is charged and discharged at about 0.2 C to about 0.5 C from one to three times.

11. The rechargeable lithium battery of claim 9, wherein the negative active material is a carbon-based negative active material.

12. The electrolyte for a rechargeable lithium battery of claim 1, wherein the film-forming compound includes a carbon-carbon unsaturated bond and a Lewis acid residual group.

13. The electrolyte for a rechargeable lithium battery of claim 1, wherein the film-forming compound is at least one of the compounds represented by the following Chemical Formulas 1 to 8: 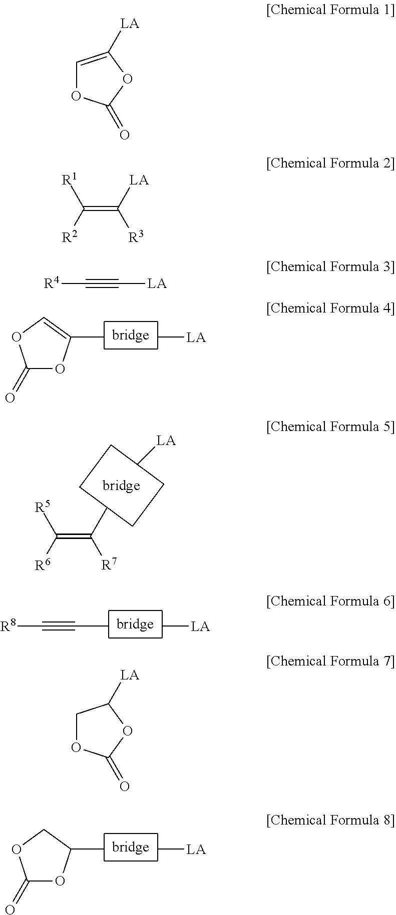
wherein, R¹ to R³ and R⁵ to R⁷ are the same or different and are each independently hydrogen; an unsubstituted or substituted alkyl group; an unsubstituted or substituted alkoxy group; an unsubstituted or substituted aryl group; or an unsubstituted or substituted amino group,
R⁴ and R⁸ are the same or different and are each independently hydrogen; an unsubstituted or substituted alkyl group; an unsubstituted or substituted alkoxy group; an unsubstituted or substituted aryl group; or an unsubstituted or substituted amino group,
LA includes a Lewis acid residual group, and
bridge is oxygen (O); an unsubstituted or substituted alkyl group; an unsubstituted or substituted aryl group; an unsubstituted or substituted ether group; an unsubstituted or substituted alkylene group; an unsubstituted or substituted alkynyl group; or an unsubstituted or substituted amide group.

14. The electrolyte for a rechargeable lithium battery of claim 13, wherein:
LA is —BR²⁰R²¹, —B(OR²⁰)(OR²¹), —AlR²⁰R²¹, or —Al(OR²⁰)(OR²¹);
R²⁰ and R²¹ are the same or different and are each independently an unsubstituted or substituted alkyl, an unsubstituted or substituted aryl. an unsubstituted or substituted alkoxy, an unsubstituted or substituted alkenyl, an unsubstituted or substituted alkynyl; or an unsubstituted or substituted amino group, or —B(OR²⁰)(OR²¹) is an unsubstituted or substituted 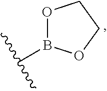 [SMILES: *B1OCCO1]
an unsubstituted or substituted 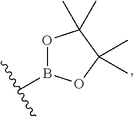 [SMILES: *B1OC(C)(C)C(C)(C)O1]
an unsubstituted or substituted 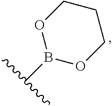 [SMILES: *B1OCCCO1]
an unsubstituted or substituted 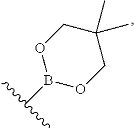 [SMILES: *B1OCC(C)(C)CO1]
an unsubstituted or substituted 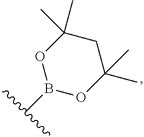 [SMILES: *B1OC(C)(C)CC(C)(C)O1]
or an unsubstituted or substituted

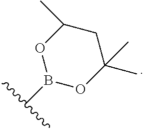 [SMILES: *B1OC(C)CC(C)(C)O1]

15. The electrolyte for a rechargeable lithium battery of claim 13, wherein LA is —B(OR²⁰)(OR²¹); and —B(OR²⁰)(OR²¹) is unsubstituted or substituted

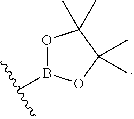 [SMILES: *B1OC(C)(C)C(C)(C)O1]

16. The electrolyte for a rechargeable lithium battery of claim 13, wherein the film-forming compound is 1-cyclohexen-1-yl-boronic acid pinacol ester, vinylboronic acid pinacol ester, allylboronic acid pinacol ester, isopropenylboronic acid pinacol ester, 2,3-diihydro-5-furylboronic acid pinacol ester, vinylboronic acid dibutyl ester, 2-cyclopropylvinylboronic acid pinacol ester, 1-pentynylboronic acid pinacol ester 3-hexenyl-3-boronic acid catechol ester, 2-(thiophen-3-yl)vinylboronic acid pinacol ester, vinylboronic acid pinanediol ester, 3,3-dimethyl-1-butynyl)boronic acid diisopropyl ester, trans-(3,3-dimethylbuten-1-yl)boronic acid pinacol ester, 1-hexen-1-yl-boronic acid pinacol ester, 2-(3,5-difluorophenyl)vinyl boronic acid pinacol ester, 3-(tert-butyldimethylsilyloxy)propene-1-yl-boronic acid pinacol ester, 4-(tert-butyldimethylsiloxy)-1-buten-1-yl-boronic acid pinacol ester, 1-hexene-1,2-diboronic acid bis(pinacol) ester, 2-(4-pentylphenyl)vinylboronic acid pinacol ester, or combinations thereof.

17. The electrolyte for a rechargeable lithium battery of claim 16, wherein the electrolyte comprises vinylethyl carbonate, vinylene carbonate, or an ethylene carbonate-based compound of the following Chemical Formula 10: 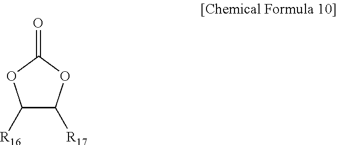
wherein, in Chemical Formula 10, R₁₆ and R₁₇ are each independently selected from the group consisting of hydrogen, a halogen, a cyano group (CN), a nitro group (NO₂), and a fluorinated C1 to C5 alkyl group, and at least one of R₁₆ and R₁₇ is selected from the group consisting of a halogen, a cyano group (CN), a nitro group (NO₂), and a fluorinated C1 to C5 alkyl group, provided that R₁₆ and R₁₇ are not simultaneously hydrogen.

18. An electrolyte for a rechargeable lithium battery, comprising:
a film-forming compound selected from diethylaluminum cyanide, diethylaluminum ethoxide, phenyl vinylsulfonate, propargyl benzenesulfonate, 2-butynyl p-toluenesulfonate, or a combination thereof;
a lithium salt; and
an organic solvent.
